(19) United States
(12) Patent Application Publication
(10) Pub. No.: US 2011/0078196 A1
(43) Pub. Date: Mar. 31, 2011

(54) RATIONED COMPUTER USAGE

(75) Inventor: Eric Jorgensen, Everett, WA (US)

(73) Assignee: MICROSOFT CORPORATION, Redmond, WA (US)

(21) Appl. No.: 12/569,672

(22) Filed: Sep. 29, 2009

(51) Int. Cl. G06F 17/30

(52) U.S. Cl. 707/783; 707/E17.059

(57) ABSTRACT

A computing system includes an access prevention module that selectively locks use of one or more system resources of that computing system. A vision-based input module is configured to recognize a data-encoded tag while the access prevention module locks use of the one or more system resources. A lookup module is configured to receive a usage profile identified by the data-encoded tag, and a login module is configured to unlock use of some to all of the one or more system resources in accordance with terms of the usage profile.

### BACKGROUND

Many situations exist in which one person may wish to limit another person's access to one or more computing devices. In one approach, a computing device may be locked so that only users with verified credentials may access the computing device. Such an approach may not be suitable when the conditions and circumstances under which access is to be granted are highly variable, or when users are unable to provide credentials in a conventional manner.

### SUMMARY

A computing system includes an access prevention module that selectively locks use of one or more system resources of that computing system. A vision-based input module is configured to recognize a data-encoded tag while the access prevention module locks use of the one or more system resources. A lookup module is configured to receive a usage profile identified by the data-encoded tag, and a login module is configured to unlock use of some to all of the one or more system resources in accordance with terms of the usage profile.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows an operating environment for rationed computer usage in accordance with an embodiment of the present disclosure.

FIG. 2 shows an example method of rationing computing access.

### DETAILED DESCRIPTION

Rationed computer usage is disclosed. A parent, teacher, or other access controller can define a usage allowance specifying the circumstances and/or conditions under which a computer user is allowed to use a computer. This usage allowance can be associated with an identifier that is embodied on a token as a data-encoded tag. For example, a token may take the form of a certificate on which the data-encoded tag is printed. The token can be given to a computer user, and the computer user may use the token to unlock a computer that is configured to ration computer usage. As such, the computer is configured to recognize the data-encoded tag and retrieve the usage allowance that is associated with the data-encoded tag. The locked computer may then unlock one or more system resources in accordance with the retrieved usage allowance.

The tokens may be used by any potential computer user, including very young computer users that are not able to login to a computer using standard login procedures (e.g., typing a username and password). The tokens are well suited for forming a computer usage economy in which a token can be given to a computer user as a reward, compensation, prize, or enticement. Such an economy can have a great deal of flexibility due to the physical nature of the token and the ability of an access controller to easily generate new tokens having different customized usage allowances.

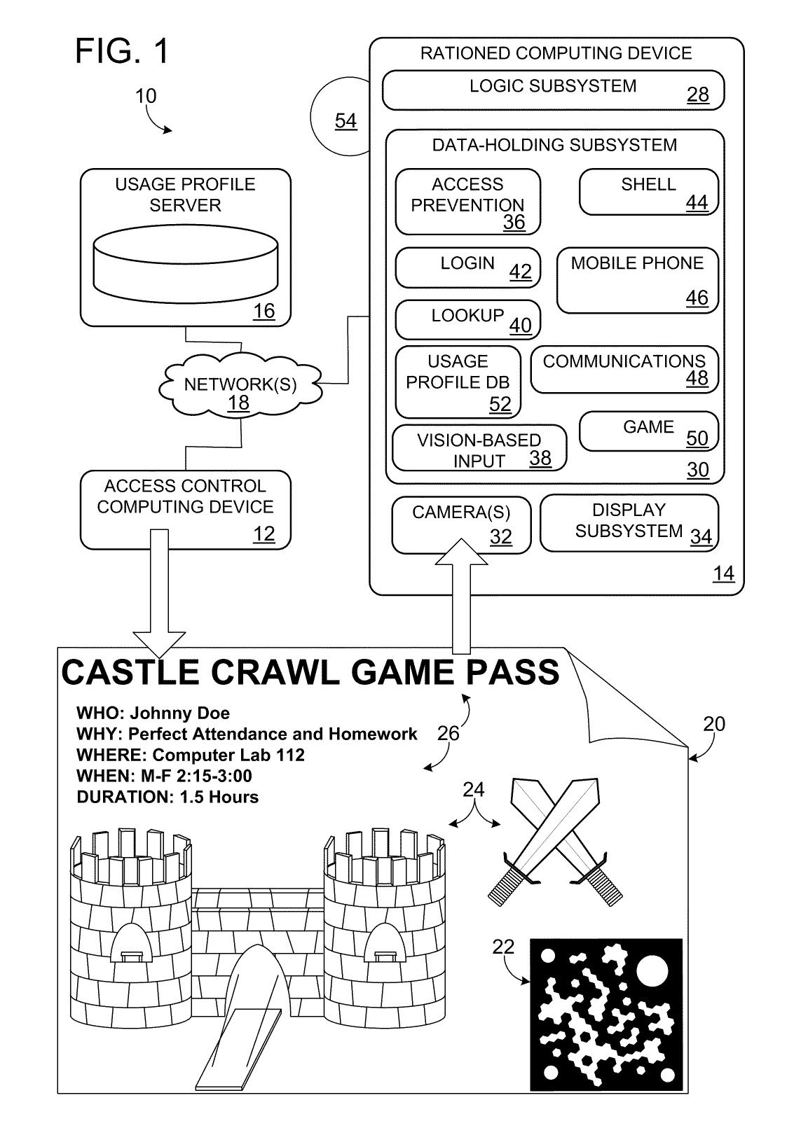

FIG. 1 schematically shows a nonlimiting operating environment 10 in which such an economy may be established. Operating environment 10 includes an access control computing device 12, a rationed computing device 14, and a usage profile server 16 communicatively coupled by one or more communications networks 18.

In the following description, access control computing device 12, rationed computing device 14, and usage profile server 16 are described as three distinct computing machines, which may be remotely located relative to one another. However, it is to be understood that some or all of the below described functions of these machines may be collapsed into the same computing machine. For example, the same computing machine that is used to generate a token can be used to lock a user from accessing that machine unless the token is used.

Access control computing device 12 can be used by an access controller (e.g., parent, teacher, etc.) to generate a token that can be used by a computer user (e.g., child, student, etc.) to unlock the rationed computing device 14. The access controller can define a usage allowance with virtually any number of parameters that specify how the rationed computing device may be used. As nonlimiting examples, the usage allowance may specify which computer(s) can be unlocked; at what time(s) a computer can be unlocked; for how long a computer can be unlocked; when unlocked, which resources shall be made accessible to the user; the interface that should be presented to the user; the settings of the computer; etc.

The access control computing device 12 may include onboard modules that allow an access controller to define a usage allowance, or the access control computing device 12 may be configured to interface with a remotely located computing module for performing this task. For example, usage profile server 16 may include a remotely accessible application for defining a usage allowance (e.g., a web application that can be accessed from any computing device having access to the Internet).

The usage allowance can be associated with a particular data-encoded tag so that when the data-encoded tag is recognized by the rationed computing device 14, the proper usage allowance can be used to selectively unlock the rationed computing device. The correspondence between the usage allowance and the data-encoded tag can be established by the access control computing device 12, the usage profile server 16, or a combination thereof, as described in more detail below.

It is to be understood that a variety of different tokens can be used. Similarly, it is to be understood that a variety of different data-encoded tags can be used. In general, a data-encoded tag can be configured so that it may be recognized by a particular type or class of rationed computing devices. That is, different types or classes of rationed computing devices may have hardware and/or software suited for recognizing a particular type of data-encoded tag. The type of data-encoded tag that is used for a particular application can be selected based on its compatibility with the types or classes of rationed computing devices that will be used.

FIG. 1 shows a nonlimiting example of a token in the form of a printed certificate 20 having a data-encoded tag 22 configured to be recognized by a camera, such as a camera in a surface computing device. In the illustrated embodiment, the data-encoded tag includes optically binary hexagonal bits, each of which can be printed as one of at least two different distinguishable colors (e.g., black and white). The number of hexagonal bits can be selected so that a desired amount of information can be encoded, including error-checking information. The data-encoded tag also includes a large circular feature that can be used to track movement of the tag; and three smaller circular features that can be used to establish an orientation of the tag. The tag can be used to represent a number (e.g., a 128 bit number) or to represent any other data that can be binary encoded.

Data-encoded tag 22 is provided as one suitable example. Other types of tags can be used without departing from the spirit of this disclosure.

In addition to data-encoded tag 22, the token may include other information. For example, printed certificate 20 includes printed artwork 24 and printed text 26. Artwork, text, and other features may be used to provide human-understandable information as to how the token can be used. Such artwork, text, and other features may also be used to make the token aesthetically attractive to a computer user, thus increasing the perceived value of the token in a computer usage economy.

Usage profile server 16 may be used in some embodiments to provide a common location from which one or more different computers may retrieve a usage profile including a usage allowance. In such embodiments, the usage allowance is sent to the usage profile server, where it can be stored. The usage allowance is associated with a corresponding data-encoded tag, which is then used to retrieve that particular usage allowance. The access control computing device 12 may associate the usage allowance with a particular data-encoded tag and send both to the usage profile server for storage. Alternatively, the access control computing device 12 may send only the usage allowance to the usage profile server 16, and the usage profile server may pick a data-encoded tag to associate with the usage allowance. In such cases, the usage profile server may then send the data-encoded tag to the access control computing device so that the access control computing device 12 can generate a token including the data-encoded tag. In still other embodiments, the functions of the access control computing device, the usage profile server, and the rationed computing device may be executed on a single computing device.

Rationed computing device 14 includes a logic subsystem 28, data-holding subsystem 30, camera(s) 32, and display subsystem 34, which are described in more detail below. The logic subsystem 28, data-holding subsystem 30, and various other components may cooperate to provide a variety of different computing functions, a nonlimiting subset of which can be attributed to access prevention module 36, vision-based input module 38, lookup module 40, login module 42, shell module 44, mobile telephone module 46, communications module 48, game module 50, and usage profile database 52.

Access prevention module 36 is used to selectively lock use of one or more system resources. For example, the access prevention module may be configured to prevent a computer user from performing most or all computing functions without first providing access credentials (e.g., username, password, biometric verification, etc.). Via display subsystem 34, the access prevention module may present a screen image with login instructions and/or fields for entering login credentials. Until access credentials are provided and verified, the computer user may be prevented from having full access to shell module 44.

It may be desirable to give some computer users full access to rationed computing device 14. Such a user can be given full access credentials, which that user may enter so that the rationed computing device will become unlocked and useable by that user. However, it may be desirable to limit or ration computer usage for some users. As such, such rationed users may not be given full access credentials that can be used to unlock the rationed computing device. Nonetheless, it may be desirable to give such rationed users limited access according to a particularly tailored computer usage allowance. In such cases, the rationed users may unlock the rationed computing device using a token including a data-encoded tag associated with the computer usage allowance.

Vision-based input may be configured to recognize a data-encoded tag while the access prevention module 36 locks use of the one or more system resources. For example, the vision-based input module may allow camera(s) 32 or another input device to view or otherwise analyze a token including a data-encoded tag while the access prevention module prevents unrestricted computer access. In some embodiments, the vision-based input module may be configured to continuously or periodically look for a data-encoded tag so that a rationed user may unlock the rationed computing device simply by holding a token in front of camera(s) 32 or another suitable input device. In other embodiments, a keyboard button, mouse button, or other input may be pressed as notification that a token is to be analyzed.

Lookup module 40 may be configured to receive a usage profile identified by the data-encoded tag. The usage profile may include a computer usage allowance that specifies how computer resources may be rationed to a user possessing the token including the data-encoded tag.

In some embodiments, the lookup module sends an identifier derived from the data-encoded tag (e.g., a 128 bit number) to a remotely-located usage profile server. The remotely-located usage profile server matches the identifier to a corresponding usage profile and/or computer usage allowance, and sends that usage profile back to the lookup module. The lookup module then receives the usage profile from the remotely-located usage profile server. The remotely-located usage profile server allows two or more different rationed computers to unlock system resources in accordance with the same token. In this way, a rationed computer user may use a particular token with different rationed computing devices (e.g., different computers in a school, different computers in a home, etc.).

In other embodiments, the lookup module 40 receives the usage profile from the usage profile database 52 based on an identifier derived from the data-encoded tag. The locally located usage profile database allows a single computer to be locked and selectively unlocked with a qualifying token, thus allowing for computer rationing on a single computer, even if such a computer is not communicatively coupled to a remote usage profile server. In some embodiments, a local usage profile database may serve as a usage profile server to other computing devices.

Login module 42 may be configured to unlock use of some to all of the one or more system resources in accordance with terms of the usage profile and/or computer usage allowance associated with the data-encoded tag. The level of computer functionality and the number of system resources that are unlocked can be set when the computer usage allowance is defined. Other constraints, such as the times the token can be used to unlock a rationed computing device and the duration for which the rationed computing device may remain unlocked may also be set when the computer usage allowance is defined.

As one nonlimiting example, printed certificate 20 includes a data-encoded tag 22 that is associated with a usage allowance that specifies that only computers in Lab 112 may be unlocked, that such computers may only be unlocked on weekdays between 2:15 PM and 3:00 PM, and that such computers may remain unlocked for a total of no more than one hour and thirty minutes. Furthermore, such computers are to be unlocked only to play the game Castle Crawl. As such, upon recognizing data-encoded tag 22 during a weekday between 2:15 PM and 3:00 PM, if rationed computing device 14 is located in Lab 112 and at least some of the one hour thirty minute duration is still available, rationed computing device 14 may launch directly into the Castle Crawl game mode without further user intervention. Such direct launching can simplify the computing experience for young and/or unsophisticated users, while at the same time limiting users from accessing unintended resources.

Of course, different computer usage allowances may be created in accordance with the preferences specified by an access controller. In some instances, a usage profile and/or computer usage allowance can be designed so that the login module unlocks use of some to all of the one or more system resources up to a maximum duration specified by the usage profile. In such cases, if a user exits an unlocked computing session before the allocated duration has been used, the usage profile and/or computer usage allowance may be automatically amended to reflect the remaining duration that has not yet been used.

In some instances, a usage profile and/or computer usage allowance can be designed so that the login module unlocks use of some to all of the one or more system resources during a time period specified by the usage profile.

In some instances, a usage profile and/or computer usage allowance can be designed so that the login module automatically sets an active-user as a user identified by the usage profile (e.g., selects an appropriate email account, chat account, and/or set of user preferences).

In some instances, a usage profile and/or computer usage allowance can be designed so that the login module automatically sets the shell module in a simple-use mode of operation specified by the usage profile (e.g., a shell interface particularly tailored to children or people with one or more disabilities).

In some instances, a computer usage allowance may grant full control of all resources to a user. In some instances, only a single application or other resource is made available, and mechanisms for opening or switching to other resources remain locked and/or disabled. In some instances, a desired subset of resources may be made available. As demonstrated by way of example above, it is to be understood that computer usage allowances of virtually all types are contemplated.

A variety of different types of devices may be locked and selectively unlocked in accordance with this disclosure. Personal computing devices, mobile computing devices, console gaming systems, network appliances, and mobile communication devices such as cellular telephones are nonlimiting examples. Such devices may be configured to provide device-specific functionality, which may be locked and selectively unlocked in accordance with the present disclosure.

As an example, rationed computing device 14 includes mobile telephone module 46, which may be used to send and receive cellular telephone calls, and/or provide other mobile telephone services. When a mobile telephone module is included, the access prevention module may selectively lock use of the mobile telephone module (e.g., so that cellular telephone calls cannot be made to or received from certain numbers—including all numbers not on a preapproved white list). In such cases, the login module may be configured to unlock use of the mobile telephone module in accordance with terms of a usage profile and/or computer usage allowance corresponding to a recognized data-encoded tag (e.g., so that cellular telephone calls can be made to or received from certain numbers).

As another example, rationed computing device 14 includes communications module 48, which may be used to send and/or receive messages (e.g., email, text, chat, audio-chat, video-chat, etc.). When a communications module is included, the access prevention module may selectively lock use of the communications module, and the login module may unlock use of the communications module in accordance with terms of a usage profile and/or computer usage allowance corresponding to a recognized data-encoded tag.

As yet another example, rationed computing device 14 includes game module 50, which may be used to play one or more different games (e.g., console games, network games, PC games, etc.). When a game module is included, the access prevention module may selectively lock use of the game module, and the login module may unlock use of the game module in accordance with terms of a usage profile and/or computer usage allowance corresponding to a recognized data-encoded tag.

While rationed computing device 14 is shown including mobile telephone module 46, communications module 48, and game module 50, it should be understood that a computing device may not include all or any of these modules. Furthermore, computing devices designed for different uses may include other modules designed to offer different functionality.

As introduced above, the herein described methods and processes may be tied to a variety of different computing systems. As an example, FIG. 1 schematically shows a computing system in the form of rationed computing device 14. As introduced above, rationed computing device 14 includes a logic subsystem 28, a data-holding subsystem 30, and display subsystem 34.

Logic subsystem 28 may include one or more physical devices configured to execute one or more instructions. For example, the logic subsystem may be configured to execute one or more instructions that are part of one or more programs, routines, objects, components, data structures, or other logical constructs. Such instructions may be implemented to perform a task, implement a data type, transform the state of one or more devices, or otherwise arrive at a desired result. The logic subsystem may include one or more processors that are configured to execute software instructions. Additionally or alternatively, the logic subsystem may include one or more hardware or firmware logic machines configured to execute hardware or firmware instructions. The logic subsystem may optionally include individual components that are distributed throughout two or more devices, which may be remotely located in some embodiments.

Data-holding subsystem 30 may include one or more physical devices configured to hold data and/or instructions executable by the logic subsystem to implement the herein described methods and processes. When such methods and processes are implemented, the state of data-holding subsystem 30 may be transformed (e.g., to hold different data). Data-holding subsystem 30 may include removable media and/or built-in devices. Data-holding subsystem 30 may include optical memory devices, semiconductor memory devices, and/or magnetic memory devices, among others. Data-holding subsystem 30 may include devices with one or more of the following characteristics: volatile, nonvolatile, dynamic, static, read/write, read-only, random access, sequential access, location addressable, file addressable, and content addressable. In some embodiments, logic subsystem 28 and data-holding subsystem 30 may be integrated into one or more common devices, such as an application specific integrated circuit or a system on a chip.

FIG. 1 also shows an aspect of the data-holding subsystem in the form of computer-readable removable media 54, which may be used to store and/or transfer data and/or instructions executable to implement the herein described methods and processes.

The terms “module” and “engine” may be used to describe an aspect of rationed computing device 14 that is implemented to perform one or more particular functions. In some cases, such a module or engine may be instantiated via logic subsystem 28 executing instructions held by data-holding subsystem 30. It is to be understood that different modules and/or engines may be instantiated from the same application, code block, object, routine, and/or function. Likewise, the same module and/or engine may be instantiated by different applications, code blocks, objects, routines, and/or functions in some cases. Furthermore, a module or engine may functionally include one or more hardware and/or peripheral machines that cooperate with software or other logical machines to enable at least some of the functionality attributed to a given module or engine.

When included, display subsystem 34 may be used to present a visual representation of data held by data-holding subsystem 30. As the herein described methods and processes change the data held by the data-holding subsystem, and thus transform the state of the data-holding subsystem, the state of display subsystem 34 may likewise be transformed to visually represent changes in the underlying data. Display subsystem 34 may include one or more display devices utilizing virtually any type of technology. Such display devices may be combined with logic subsystem 28 and/or data-holding subsystem 30 in a shared enclosure, or such display devices may be peripheral display devices.

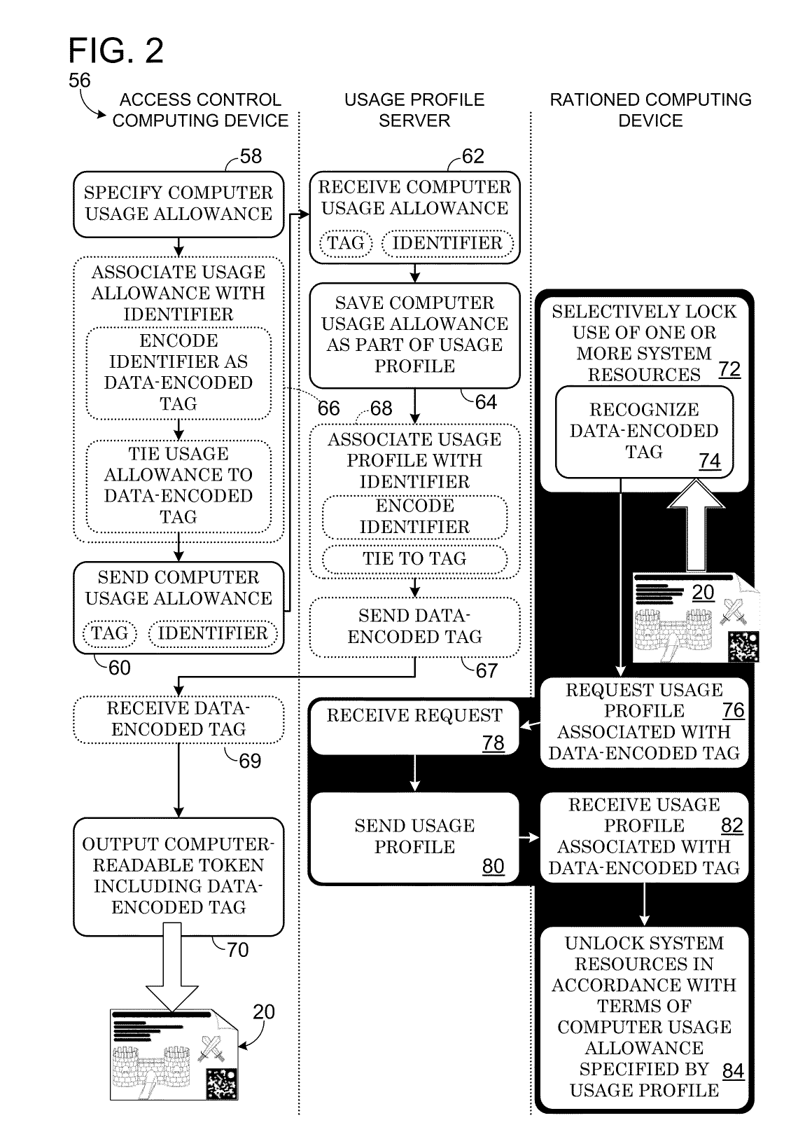

FIG. 2 shows an example method 56 of rationing computing access. At 58, method 56 includes specifying a computer usage allowance. As discussed above, a computer usage allowance may be specified using an access control computing device. The computer usage allowance can define the conditions and circumstances under which a computing device is to be unlocked. The computer usage allowance can be specified to provide a user with a desired level of computer access at a desired time and/or for a desired duration, for example.

At 60, method 56 includes sending the computer usage allowance to a remotely-located usage profile server. At 62, method 56 includes receiving the computer usage allowance at the remotely-located usage profile server, and at 64 method 56 includes saving the computer usage allowance as part of a usage profile. The usage profile server may serve as a central repository where each usage profile and related computer usage allowance may be accessed by one or more compatible rationed computing devices.

As indicated at 66 and 68, method 56 includes tying the usage profile to a data-encoded tag. The usage profile can be tied to a data-encoded tag by an access control computing device and/or a usage profile server, depending on the implementation, as described above. In both cases, a particular usage profile, and thus computer usage allowance, is tied to a particular data-encoded tag with a one-to-one correspondence. In this way, the data-encoded tag can be used to lookup a particular computer usage allowance specified for a specific situation. In some embodiments, an identifier, such as a number (e.g., a 128 bit number) may serve as an intermediary between the computer usage allowance and the data-encoded tag. In other words, a data-encoded tag can be translated into a number that the tag encodes, and that number can be used as an index or lookup to find a particular computer usage allowance. As shown at 67 and 69, the usage profile server may send to the access control computing device the data-encoded tag and/or an identifier that can be encoded into the data-encoded tag in embodiments where the data-encoded tag is chosen by the usage profile server.

At 70, method 56 includes outputting a computer-readable token including the data-encoded tag. As an example, the token can be output by printing the data-encoded tag on a certificate. Printed certificate 20 is a nonlimiting example of such a token. Once generated, the token may serve as a currency in a computer usage economy. The tokens may be physically given to rationed computer users, and the tokens may be physically used by such users to gain access to rationed computing devices.

At 72, method 56 includes selectively locking use of one or more system resources of a rationed computing device. As described above, such resources may be locked so as to limit access to the computing device to only those users that are properly credentialed.

At 74, method 56 includes the rationed computing device recognizing the data-encoded tag while the one or more system resources are locked. The data-encoded tag can be recognized in any suitable manner. In some embodiments, the data-encoded tag is recognized with one or more digital cameras (e.g., camera(s) 32 of FIG. 1) configured to capture an image of the data-encoded tag and pass the image to a vision-based input module (e.g., vision-based input module 38 of FIG. 1). In some embodiments, the rationed computing device may be a surface computing device including a rear-projector and a rear-projection display surface. In such embodiments, the one or more digital cameras may be configured to capture the image of the data-encoded tag when the data-encoded tag is positioned on the rear-projection display surface.

At 76, method 56 includes the rationed computing device requesting the usage profile and/or the computer usage allowance associated with a recognized data-encoded tag. At 78, method 56 includes the usage profile server receiving this request, and at 80 method 56 includes the usage profile server sending the relevant usage profile and/or computer usage allowance to the rationed computing device. Accordingly, at 82, method 56 includes the rationed computing device receiving the usage profile and/or computer usage allowance tied to the data-encoded tag.

At 84, method 56 includes unlocking use of some to all of the one or more system resources in accordance with terms of the computer usage allowance specified by the usage profile. In this way, the computer usage allowance specified at 58 can be used to control the level of computing access that is granted at 84. Furthermore, from the perspective of the rationed computer user, the physical embodiment of a token (e.g., printed certificate 20) is all that is needed to unlock the rationed computing device.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A computing system, comprising:
an access prevention module to selectively lock use of one or more system resources;
a vision-based input module configured to recognize a data-encoded tag while the access prevention module locks use of the one or more system resources;
a lookup module to receive a usage profile identified by the data-encoded tag;
a login module to unlock use of some to all of the one or more system resources in accordance with terms of the usage profile.

2. The computing system of claim 1, where the login module unlocks use of some to all of the one or more system resources up to a maximum duration specified by the usage profile.

3. The computing system of claim 1, where the login module unlocks use of some to all of the one or more system resources during a time period specified by the usage profile.

4. The computing system of claim 1, where the lookup module sends an identifier derived from the data-encoded tag to a remotely-located usage profile server and receives the usage profile from the remotely-located usage profile server.

5. The computing system of claim 1, further comprising a usage profile database, where the lookup module receives the usage profile from the usage profile database based on an identifier derived from the data-encoded tag.

6. The computing system of claim 1, where the login module automatically sets an active-user as a user identified by the usage profile.

7. The computing system of claim 1, further comprising a shell module, where the login module automatically sets the shell module in a simple-use mode of operation specified by the usage profile.

8. The computing system of claim 1, further comprising one or more digital cameras to capture an image of the data-encoded tag and pass the image to the vision-based input.

9. The computing system of claim 8, further comprising a rear-projector and a rear-projection display surface, where the one or more digital cameras are configured to capture the image of the data-encoded tag when the data-encoded tag is positioned on the rear-projection display surface.

10. The computing system of claim 1, further comprising a mobile telephone module, where the access prevention module selectively locks use of the mobile telephone module and the login module unlocks use of the mobile telephone module in accordance with terms of the usage profile.

11. The computing system of claim 1, further comprising a communications module, where the access prevention module selectively locks use of the communications module and the login module unlocks use of the communications module in accordance with terms of the usage profile.

12. The computing system of claim 1, further comprising a game module, where the access prevention module selectively locks use of the game module and the login module unlocks use of the game module in accordance with terms of the usage profile.

13. A method of rationing computing access, the method comprising:
specifying a computer usage allowance;
sending the computer usage allowance to a remotely-located usage profile server;
saving the computer usage allowance as part of a usage profile;
tying the usage profile to a data-encoded tag;
outputting a computer-readable token including the data-encoded tag;
selectively locking use of one or more system resources;
recognizing the data-encoded tag while the one or more system resources are locked;
receiving the usage profile tied to the data-encoded tag; and
unlocking use of some to all of the one or more system resources in accordance with terms of the computer usage allowance specified by the usage profile.

14. The method of claim 13, where outputting the computer-readable token includes printing the data-encoded tag.

15. The method of claim 13, where recognizing the data-encoded tag includes capturing an image of the data-encoded tag with one or more digital cameras.

16. The method of claim 13, where unlocking use of some to all of the one or more system resources includes unlocking use of some to all of the one or more system resources during a time period specified by the usage profile.

17. The method of claim 13, where unlocking use of some to all of the one or more system resources includes unlocking use of some to all of the one or more system resources up to a maximum duration specified by the usage profile.

18. The method of claim 13, further comprising automatically setting a shell module in a simple-use mode of operation specified by the usage profile.

19. The method of claim 13, further comprising automatically setting an active-user as a user identified by the usage profile.

20. A data-holding subsystem holding instructions executable by a logic subsystem to:
selectively lock use of one or system resources;
recognize a visually-input data-encoded tag while use of the one or more system resources is locked;
receive a usage profile identified by the data-encoded tag; and
unlock use of some to all of the one or more system resources in accordance with terms of the usage profile.
